(19) United States
(12) Patent Application Publication
(10) Pub. No.: US 2018/0246998 A1
(43) Pub. Date: Aug. 30, 2018

(54) Mobile Application Performance Simulation

(71) Applicant: Google Inc., Mountain View, CA (US)

(72) Inventors: Ofer Ronen, Dublin, CA (US); Keith Simmons, Redwood City, CA (US)

(21) Appl. No.: 14/257,797

(22) Filed: Apr. 21, 2014

Related U.S. Application Data
(60) Provisional application No. 61/854,312, filed on Apr. 22, 2013.

(51) Int. Cl. G06F 17/50

(52) U.S. Cl. CPC G06F 17/5009

(57) ABSTRACT

The present invention provides methods of and systems for simulating performance of a mobile application. A mobile application is installed on a plurality of wireless mobile devices, the plurality of mobile devices including disparate mobile device configurations and wireless network connection types. Operational data resulting from operating the mobile application on the plurality of mobile devices is collected, the operational data representing performance of the mobile application for each of a plurality of combinations of mobile device configuration and wireless network connection type. Statistical performance parameters are determined from the operational data. Performance of the mobile application is simulated using the determined statistical performance parameters for a selected combination of mobile device configuration and wireless network connection type.

This application claims the benefit of U.S. Provisional Application No. 61/854,312, filed Apr. 22, 2013, the entire contents of which are hereby incorporated by reference.

### BACKGROUND OF THE INVENTION

The present invention relates to the field of wireless mobile devices and software applications installed thereon. More particularly, the present invention relates to simulating performance of such devices and software applications.

There are tens of varying smart phone devices used by individuals, tens of mobile operating system versions, tens of connection types, and almost limitless locations where users use their smart phones. Currently Samsung, Motorola, Apple, Sony, HTC, LG, RIM, Huawei, Lenovo, ZTE, and Nokia manufacture the most popular mobile devices. Currently Google, Apple, Microsoft, and RIM create the most popular operating systems. In the United States Verizon, AT&T, Sprint, and Comcast, provide popular smart phone connections, whether using a cellular network or a Wi-FI network. Thus there are millions of smart phone configurations possible due to various combinations of hardware types, operating system version, connection type, and geography used by individuals with smart phones. This diversity of configurations creates a challenge for mobile application developers interested in experiencing how their application performs on various configurations.

Existing solutions from companies like Keynote Systems use a panel based approach to capture the mobile application performance across users that opt-in to be tracked by such services as they use their mobile applications. While these solutions capture performance they do not provide the application developer with a capability to experience the performance of their application.

Other solutions record user sessions and are then played back to the developer in the form of a video of the end user session. These solutions are limited in that the developer is forced to passively view the fixed session. These solutions do not let the developer play around with the application and see the responsiveness of the application within different configurations.

There is a need for a solution that tracks performance of mobile applications as they are used by end users and then uses that information to simulate for the application developers the performance of their applications, for example, per handset type, operating system version and configuration, connection type, and location.

### SUMMARY OF THE INVENTION

The present invention provides methods of and systems for simulating performance of a mobile application. A mobile application is installed on a plurality of wireless mobile devices, the plurality of mobile devices including disparate mobile device configurations and wireless network connection types. Operational data resulting from operating the mobile application on the plurality of mobile devices is collected, the operational data representing performance of the mobile application for each of a plurality of combinations of mobile device configuration and wireless network connection type. Statistical performance parameters are determined from the operational data. Performance of the mobile application is simulated using the determined statistical performance parameters for a selected combination of mobile device configuration and wireless network connection type.

### BRIEF DESCRIPTION OF THE DRAWINGS

The present invention is described with respect to particular exemplary embodiments thereof and reference is accordingly made to the drawings in which:

FIG. 1 illustrates a system for simulating mobile application performance that includes a network, mobile application developer computer, performance simulation server, production mobile application store server, production user group, and mobile devices;

FIG. 2 illustrates a mobile device and its relevant components including an application with a performance library that collects processor, memory, battery, and network performance information;

FIG. 3 illustrates a performance simulation server including a stored performance library code and its databases;

FIG. 4 shows how a performance library is installed in a mobile application, then how it is distributed and used by a production user group;

FIG. 5 shows how a performance simulation server calculates simulation averages per mobile configuration based on production performance data;

FIG. 6 shows how a developer can view per mobile configuration a performance simulation of an application; and

FIG. 7 is a block diagram of a machine in the form of a computer system that may form a server forming part of a network system.

### DETAILED DESCRIPTION OF A PREFERRED EMBODIMENT OF THE INVENTION

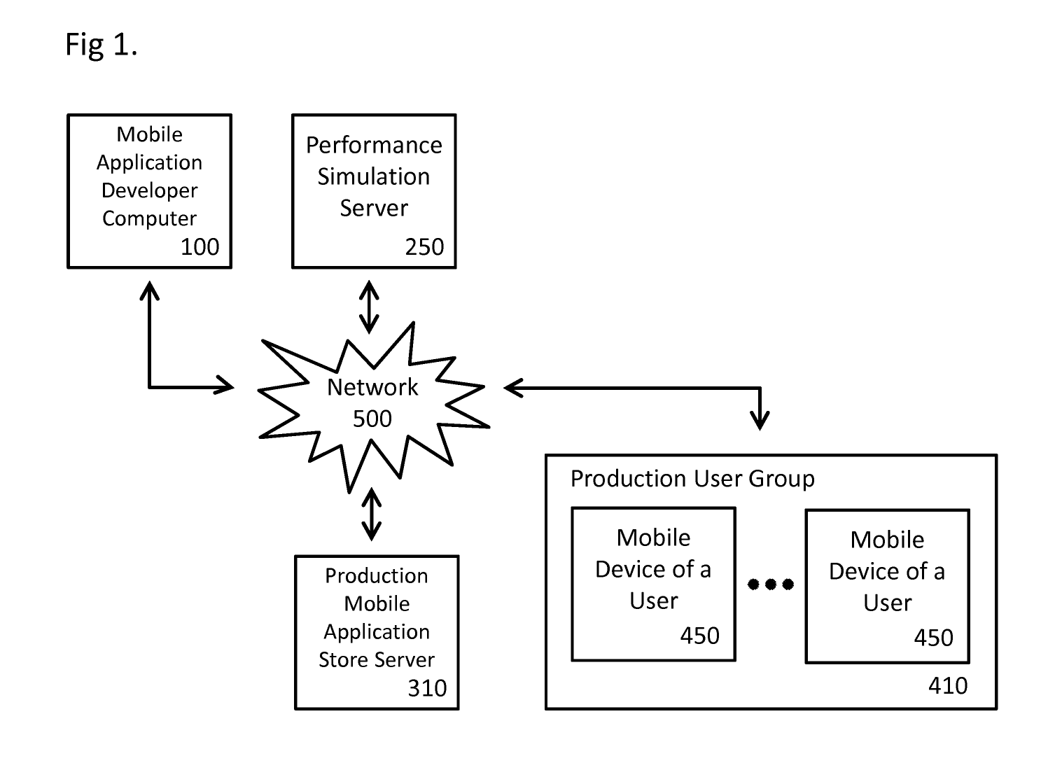

FIG. 1 illustrates a mobile application developer 100 using a personal computer to access a performance simulation server 250 over a network 500 such as the Internet. The developer 100 downloads a performance library and then includes and instantiates the performance library in their mobile application. The application developer 100 can upload over a network 500 to a production mobile application store server 310 the application with the performance library included. A mobile device user 450 connects over a network 500 such as a Wi-Fi network or cellular network to the production mobile application store server 310 to download the application. The mobile device 450 then connects to the performance simulation server 250 to send application performance data that is collected. Performance data can be collected from a group 410 of mobile devices 450 having various different configurations. The group 410 does not need to be exhaustive of all possible configurations. The developer 100 can then run a simulator application program on their computer 100 and using data from the performance simulation server 250 experience simulated performance of their application using different mobile configurations, including varying mobile handsets 450, mobile operating system versions, connection types, and locations.

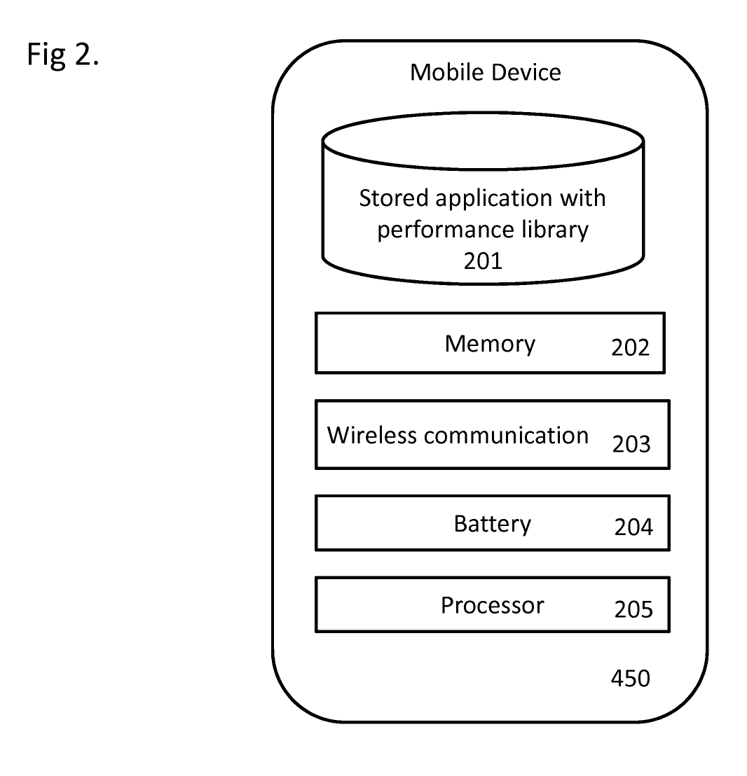

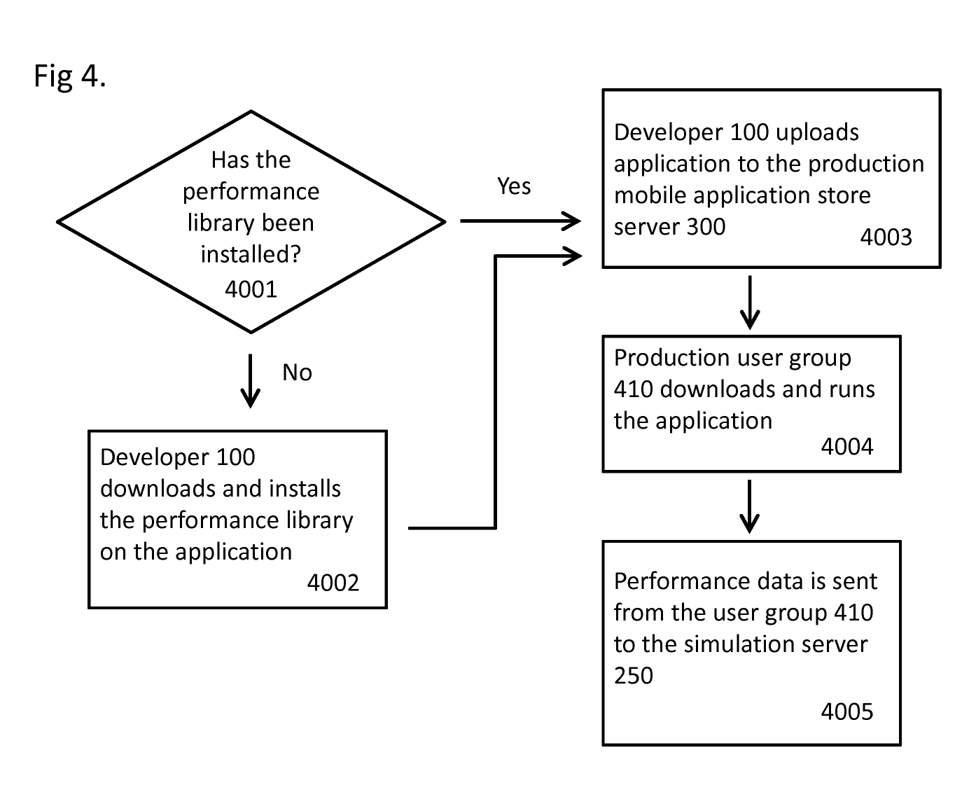

FIG. 2 illustrates a mobile device 450 with storage that includes a mobile application with an included performance library 201. The performance library monitors the performance of the application, including use of memory 202, wireless communication 203, battery 204, and processor 205. The performance library is preferably included in the mobile application by the developer 100, as described in FIG. 4. Those skilled in the art could develop such a performance library for mobile applications that is optimized to collect performance information without significantly slowing down the application that contains it. The performance library preferably monitors and records data representative of various performance parameters observed while a particular mobile application is running on the mobile device. Mobile device configuration information associated with the observed performance parameters which can include, for example, the mobile device type and wireless connection type, is also recorded. The device configuration information can be recorded by the performance library. The device configuration information can be uploaded to the performance simulation server 250 along with observed performance data. As an example, the performance library 201 can monitor per type of mobile device 450 the memory 202 allocated per function used by the mobile application, and the maximum memory 202 that is used by the application per user session relative to the total available memory per type of mobile device 450. The performance library 201 can also monitor the wireless communication 203 to measure the duration of network requests made from the application whose performance can be negatively affected by slow network connections, by large amounts of data that mobile users download, or by type of mobile device 450. The performance library 201 can monitor the amount (e.g. the rate) that the application drains the battery 204 per type of mobile device 450 type. Also the performance library 201 can monitor the processor 205 to measure the run-time per function call in the application per type of mobile device 450. The performance library 201 can also measure the frame rate, that is the rate at which the handset screen is redrawn. For example in iOS applications the frame rate can be closely estimated by timing the run loop which draws to the handset screen. If the run loop takes 0.1 seconds to run then the frame rate is 10 frames per second. It will be apparent that other performance parameters can be monitored and recorded.

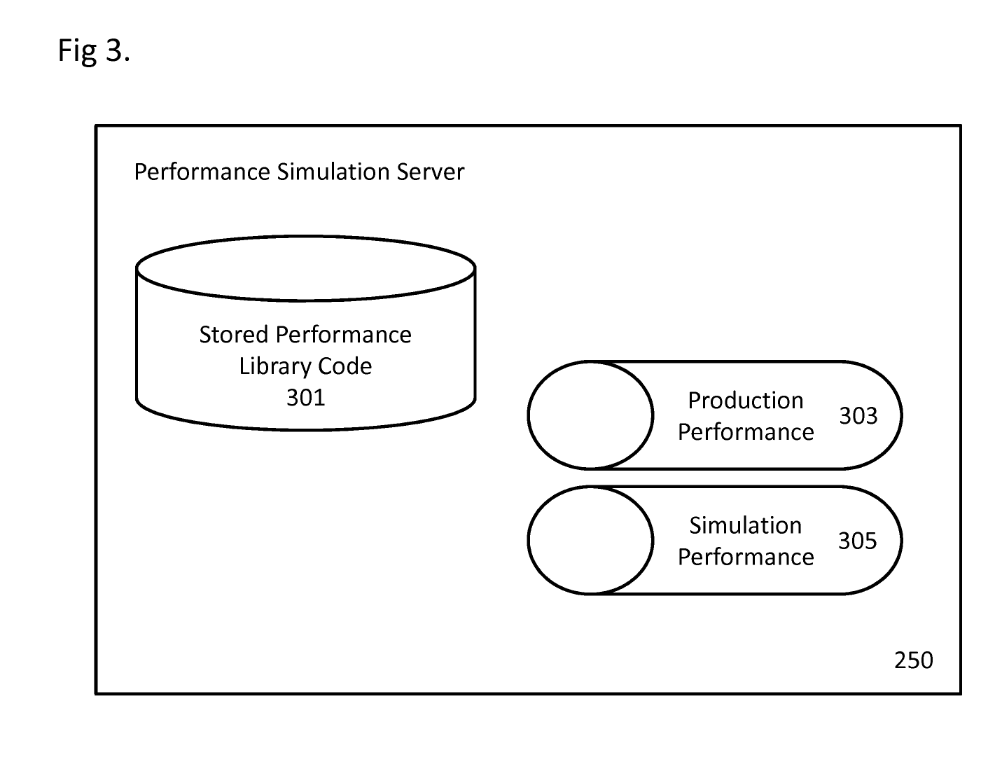

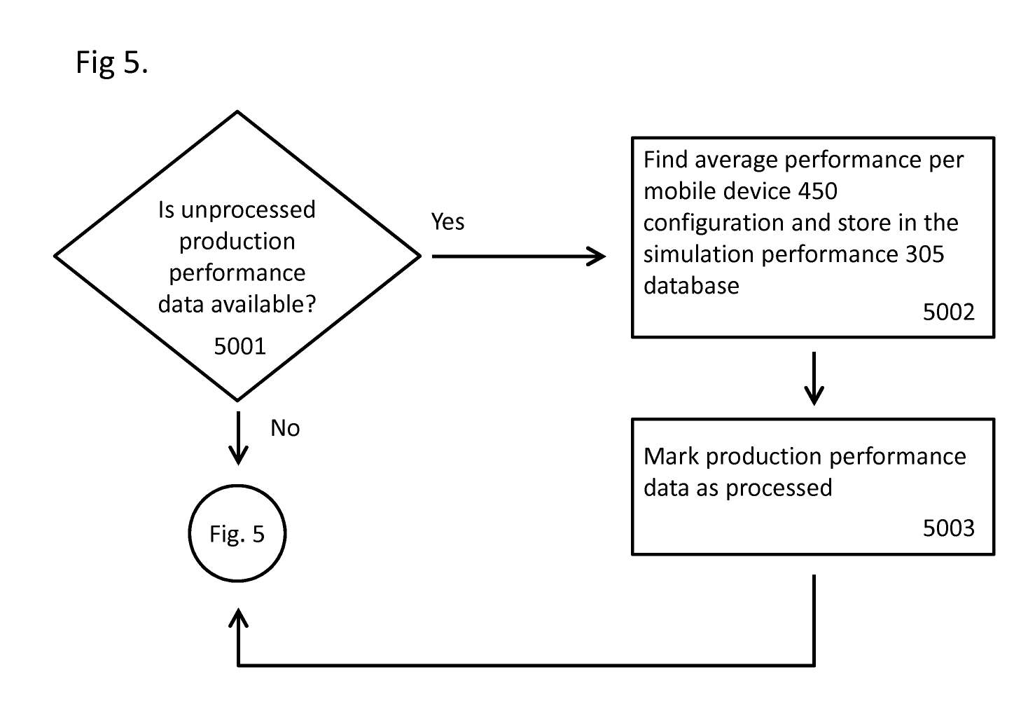

FIG. 3 describes the makeup of the performance simulation server 250, which includes the performance library in storage 301, a production performance database 303 to store data (also referred to herein as operational data) that is sent by mobile devices 450 in a production user group 410. The production performance database 303 preferably stores a name or other identifier of an application for which the performance data is collected, a mobile device 450 type and operating system version that data is collected on and possibly other configuration and location information, and performance measures associated with the mobile device, such as its memory 202, wireless communication 203, battery 204, and processor 205 performance. The production performance database 303 can also store an indication associated with the performance data that indicates whether the performance data was processed. Capturing of the production performance data is described in FIG. 4. In addition, a simulation performance database 305 stores simulation data, such as average performance values per mobile configuration as described in FIG. 5. For example this can include simulation performance data per a particular mobile device 450 type and operation system version, per connection type and location.

FIG. 4 shows how the performance library can be installed in a mobile application, then how it can be distributed and used by a production user group 410. In step 4001, the developer 100 checks if the performance library was installed on the mobile application. If not, then in step 4002 the developer 100 downloads the stored performance library code 301 from the performance simulation server 250 and installs the performance library in the mobile application. Those skilled in the art would know how to install a library in a mobile application. Then in step 4003, which is also reached if the performance library was already installed in the application, the developer 100 uploads the application to the production mobile application store server 310. In step 4004, members of the production user group 410 download over the network 500 the application onto their mobile devices 450 from the production mobile application store server 310. In step 4005, after the production user group 410 executes the application on their mobile devices 450, the mobile devices 450 send to the performance simulation server 250 the performance information collected by the performance library. The performance simulation server 250 then stores that data in the production performance 303 database. The data can either be sent in batches periodically or can be sent in real-time as it is collected.

FIG. 5 describes a how the performance simulation server 250 takes production performance data and calculates statistical performance parameters, such as averages, that are stored in the simulation performance database 305. In step 5001 the performance simulation server 250 checks if there is an application that is flagged as having unprocessed production performance data in the production performance 303 database. If not then the performance simulation server 250 repeats step 5001, optionally after waiting a fixed amount of time, otherwise in step 5002, the performance simulation server for a given application 201 per mobile device 450 configuration processes the data to determine statistical performance, which can include finding the average production performance data, and stores it in the simulation performance database 305. Then in step 5003 the performance simulation server 250 marks the data processed in step 5002 as processed in the production performance 303 database. FIG. 5 can then be repeated for any unprocessed data.

In one example the average processor and memory performance is calculated in step 5002 for an application based per mobile device 450 configuration. For instance all production performance 302 data for an application captured on a Samsung Galaxy S III mobile device 450 running version 2.1 of the Android operating system is averaged out and stored in the simulation performance database 305. The performance data is calculated and stored for each combination of mobile device 450 and operating system version found for the application in the production performance database 303.

In another example the average battery performance is calculated in step 5002 for each mobile device 450 configuration. For instance the average battery drain can be calculated from production performance 303 data for an application that ran on a Samsung Galaxy S III mobile device 450 with version 3.2 of the Android operating system, with the Wi-Fi, Bluetooth, and GPS services turned on.

In yet another example the average performance can be calculated in step 5002 based on location and connection type. If the production performance 303 data for an application was captured in Atlanta, Ga. using the Verizon Wireless CDMA network, or using a Comcast connection over Wi-Fi, then the performance simulation server 250 can calculate the average network lag for each such location and connection type.

In an alternate embodiment of the invention in step 5002 in addition to the average performance, or instead of the average performance, the performance simulation server 250 calculates one or more different performance parameters, such as a performance median, mode, minimum, maximum, standard deviation, and percentiles. For instance the 90th percentile might be a performance measure that is slower than 90% of the measures captured for a given application version, mobile handset 450 type, and operation system version.

In yet another embodiment, in step 5002 instead of calculating average performance for an exhaustive list of mobile device 450 configurations, locations, and network connections, the most popular ones can be calculated, or ones requested by the mobile application developer 100.

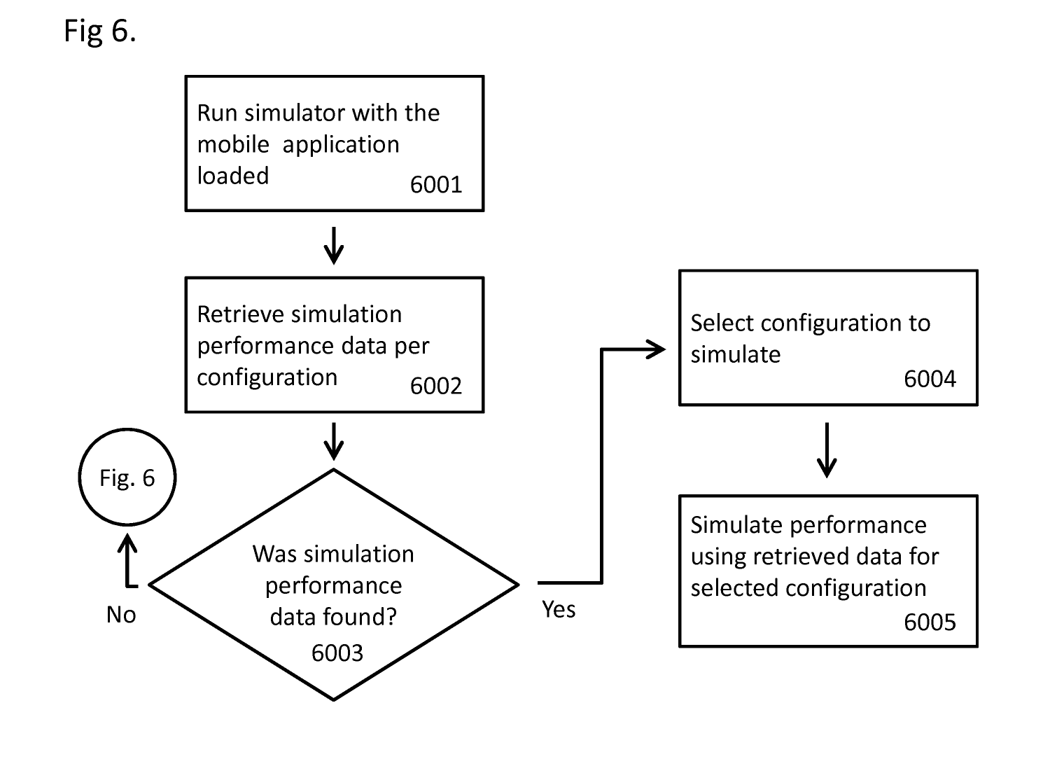

FIG. 6 illustrates how the developer 100 can select which simulated performance of their application to experience for varying mobile device 450 configurations, locations, and connection types. In step 6001 the developer 100 runs their mobile application using a simulator. The simulator can be, for example, an emulator for the mobile operating system that the application was built in. Examples of mobile operating system emulators include CodeRebel for iOS or Manymo and Android Emulator for Android. The simulator can either be installed on the developer computer 100 or it can be viewed within a Web browser like Chrome and served to the developer 100 by the performance simulation server 250.

In step 6002 the simulator receives all of the average performance data for the mobile application being simulated by the performance simulation server 250. That data is used by the simulator to simulate the average performance experienced by the production user group 410. For the simulator to receive the performance data and then incorporate it into the mobile app simulation the simulator might need to be modified by those skilled in the art.

In step 6003 if no statistical performance data is retrieved then FIG. 6 is repeated at a later time when such data is available. Otherwise in step 6004 the developer 100 selects a mobile configuration, such as a mobile device 450 type, mobile operating system version, connection type, and location. Then in step 6005 the simulator uses the statistical performance data for the parameters selected in step 6004 to provide a simulated experience of the mobile application. For instance if a certain action, like a button press, in the mobile application took 3.0 seconds on average for the production user group 410 on a Galaxy S III mobile device 450 with version 3.2 of the Android operating system then the simulator would experience a 3.0 second delay when the developer 100 performs that action. Another example is if the average battery drain was 7% an hour for the production user group 410 on an HTC First phone with version 2.2 of the Android operating system on the AT&T cellular network then the simulator would simulate a 7% an hour battery drain.

In an alternate embodiment of the invention the developer uses a simulator in a mobile device 450, instead of the mobile application developer computer 100, to view and experience the simulated performance.

In another embodiment the developer uses a modified version of the performance library on a mobile device 450 to experience the simulated performance of their mobile application. In this embodiment a separate mobile application on the mobile device can be used to perform steps 6002, 6003, 6004. Then to perform step 6005, the application with the modified performance library is run. The modified performance library then checks which configuration was selected for simulation in step 6004 and uses the statistical performance data for that configuration to simulate the mobile application experience. As previously described, if a certain action takes 3.0 seconds among the production user group 410 then the modified performance library makes a best effort to ensure that the action takes 3.0 seconds to complete.

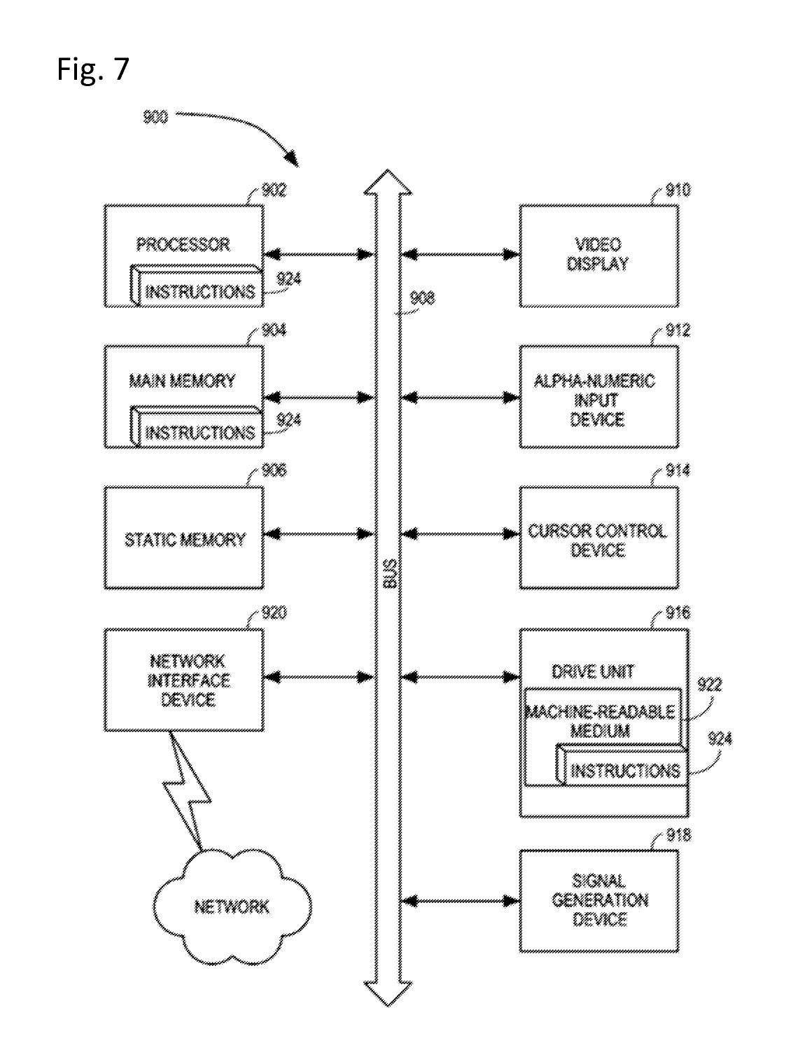

FIG. 7 shows a machine 900 in the exemplary form of the server or a personal computer as hereinbefore described within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, and optical and magnetic media.

It should be understood that “computer system” as used herein can comprise a single computer or multiple computers that are connected to one another over a network.

While certain representative embodiments and details have been shown for purposes of illustrating the invention, it will be apparent to those skilled in the art that various changes in the methods and apparatus disclosed herein may be made without departing from the scope of the invention which is defined in the appended claims.

1-26. (canceled)

27. A method for simulating a mobile application, the method performed by an apparatus and comprising:
receiving, from a performance simulation server that is separate from the apparatus, performance data for each configuration of a group of mobile handsets on which the mobile application was executed, each performance data comprising configuration-specific performance data for each configuration as collected by the performance simulation server from the group of mobile handsets;
receiving a selection of one of the mobile handset configurations; and
simulating the mobile application, the simulating based on the performance data associated with the selected mobile handset configuration.

28. The method as recited in claim 27, wherein the apparatus performing the method is a mobile handset or a personal computer.

29. The method as recited in claim 27, wherein receiving the performance data for the mobile application receives an average of performance data collected, by the performance simulation server, from the group of mobile handsets.

30. The method as recited in claim 29, wherein the performance data collected by the simulation server is collected from a performance library instantiated in the mobile application from the group of mobile handsets.

31. The method as recited in claim 30, wherein the performance library instantiated in the mobile application monitors memories, wireless communications, batteries, or processors of the group of mobile handsets.

32. The method as recited in claim 27, wherein receiving the selection of a mobile handset configuration receives a selection of one or more of a mobile handset type, a mobile operating system version, a connection type, or a location.

33. The method as recited in claim 27, wherein the simulating is performed by an emulator for a mobile operating system in which the mobile application was built.

34. A method for presenting a view of a simulation of a mobile application, the method performed by an apparatus and comprising:
receiving a selection of a mobile handset configuration, the mobile handset configuration selected from one or more of a mobile operating system version, a connection type, and a location;
sending, to a simulation server that is separate from the apparatus, the selected mobile handset configuration; and
presenting, via a web browser associated with the apparatus, a view of a simulation of the mobile application, the simulation served by the performance simulation server.

35. The method as recited in claim 34, wherein the apparatus performing the method is a mobile handset or a personal computer.

36. (canceled)

37. The method as recited in claim 34, wherein presenting the view of the simulation presents a view of a simulation that is based, at least in part, on performance data for the selected mobile handset configuration, the performance data collected by the simulation server from a group of mobile handsets.

38. The method as recited in claim 37, wherein the performance data collected from the group of mobile handsets is collected from a performance library instantiated in the mobile application on the group of mobile handsets.

39. The method as recited in claim 38, wherein the performance library instantiated in the mobile application monitors memories, wireless communications, batteries, or processors of the group of mobile handsets.

40. An apparatus comprising:
a processor;
a display; and
a machine-readable medium storing instructions, that when executed by the processor, cause the apparatus to:
receive a selection of a mobile handset configuration, the mobile handset configuration selected from one or more of a mobile operating system version, a connection type, and a location;
send, to a performance simulation server that is remote from the apparatus, the selected mobile handset configuration; and
present, via the display, a simulation of a mobile application, the simulation based on the selected mobile handset configuration, performed by the performance simulation server, and served to the apparatus by the performance simulation server.

41. The apparatus as recited in claim 40, wherein the apparatus is a mobile handset or a personal computer.

42-45. (canceled)

46. The apparatus as recited in claim 40, wherein the simulation is presented through a web browser.

47. The apparatus as recited in claim 40, wherein the simulation is based on performance data collected by the server for the selected mobile handset configuration and from of a group of mobile handsets on which the mobile application was executed.

48. The method as recited in claim 47, wherein the performance data includes battery drain rate.

49. The method as recited in claim 47, wherein the performance data includes a network lag.

50. The method as recited in claim 47, wherein the performance data includes a button press delay.

51. The method as recited in claim 47, wherein the performance data includes a processor performance and a memory performance.
